(19) United States
(12) Patent Application Publication
(10) Pub. No.: US 2026/0277754 A1
(43) Pub. Date: Sep. 17, 2026

(54) SYSTEMS AND METHODS OF EFFICIENT AND RESILIENT DATABASE MIGRATION

(71) Applicant: Micro Focus LLC, Wilmington, DE (US)

(72) Inventors: Vamsi Krishna, Bangalore (IN); Harinath Jarugula, Bangalore (IN)

(73) Assignee: Micro Focus LLC, Wilmington, DE (US)

(21) Appl. No.: 19/079,639

(22) Filed: Mar. 14, 2025

(51) Int. Cl. G06F 11/20; G06F 16/21

(52) U.S. Cl. CPC G06F 11/2082; G06F 16/214

(57) ABSTRACT

Migrating data, from a source database to a destination database, may introduce errors.

Simply re-migrating the data to resolve any discrepancies may be excessively burdensome. By creating a source Merkle tree of hash values from the source database and a corresponding Merkle tree of hash values of the destination database, any discrepancies can be quickly identified and narrowed to a subset of the affected rows. The discrepancies may be resolved, such as by re-hashing the destination rows when a field(s) therein are of a different datatype than the corresponding source rows' datatype. If the hashes are then the same, then the difference may be accepted as the result of different datatypes. If differences remain, then other resolutions may be implemented.

### FIELD OF THE DISCLOSURE

The invention relates generally to systems and methods for migrating database records and particularly to efficiently identifying copying errors for rectification.

### BACKGROUND

Database migration is the process of transferring data from one system to another and is a critical task for many organizations. Migrations often fail to accurately copy all of the source data to the destination. This may occur due to copy errors introduced when a migration is stopped and restarted or due to data format differences between the source and destination databases. For example, a date field in a source database may use a string and convert the string value to an integer value or a more complex date structure for storage in the destination database. As a result, the source and destination databases will not be identical. Data format differences may have the same underlying information and, if known, may be ignored, but ignoring a whole migration may fail to capture more substantial differences.

Databases may require migration to a different platform, vendor, underlying hardware, etc., in order to keep up with the demands of the database's users. As businesses evolve and technology advances, the need to migrate data from one database to another becomes increasingly prevalent. This can be driven by various factors, including: Cost Reduction: Migrating to a more cost-effective database solution can significantly reduce licensing and operational costs; Performance Optimization: Upgrading to a high-performance database can improve application response times and overall system performance; Scalability: Migrating to a scalable database can accommodate future growth and evolving business needs; Vendor Lock-in Reduction: Moving to an open-source or cloud-based database can reduce dependence on specific vendors and their licensing terms; Data Center Consolidation: Consolidating multiple databases into a single platform can streamline operations and reduce infrastructure costs; and Regulatory Compliance: Migrating to a compliant database can help organizations meet industry-specific regulations and data privacy standards.

However, traditional data migration methods of the prior art, such as full data extraction, transformation, and load (ETL), often face significant challenges, including: Time-Consuming: Full data transfers can be extremely time-consuming, especially for large datasets; Downtime: Full data transfers can lead to significant downtime, impacting business operations; Data Consistency: Ensuring data consistency between the source and target systems can be complex and error prone; Error-Prone: Data corruption, network failures, and other unforeseen issues can lead to data loss or inconsistencies; and Lack of Resumability: Traditional methods often lack mechanisms for resuming failed migrations, requiring a complete restart.

### SUMMARY

In a large enterprise database, with a complex schema, the database may comprise hundreds of tables and millions of rows. The database may power critical business applications, storing sensitive customer data, financial transactions, and operational insights. The organization decides to migrate this database to a new platform, perhaps due to performance limitations, scalability needs, or cost considerations.

A common approach to such a massive migration involves a table-by-table migration strategy, comprising: analyzing the database schema to identify dependencies between tables and determine the optimal migration order; extracting data from the source database, often table by table; transforming the extracted data to match the target database schema, including data cleaning, validation, and mapping; loading the transformed data into the target database, typically using bulk insert operations; and performing post-migration consistency checks to ensure data integrity and accuracy.

Challenges of the Traditional Approach:
(A) Data Consistency and Integrity, which may include (1) concurrent updates: While the source database is offline, it's still susceptible to changes, such as updates to “lastAccessedTime,” which can lead to inconsistencies in the target database; (2) data quality issues, such as missing values, incorrect data types, or invalid data formats, can impact the accuracy and completeness of the migrated data; and/or (3) Foreign Key Constraints, such as maintaining referential integrity between tables can be complex, especially when dealing with circular dependencies.
(B) Error-Prone and Lack of Resumability, which may include (1) partial failures, such as when a migration job fails due to network issues, database errors, or software bugs, the entire process may need to be restarted, leading to significant downtime and resource consumption; and/or (2) a lack of resumability as traditional methods often lack mechanisms for resuming failed migrations, requiring a complete restart.
(C) Data Type Mismatches: The source and target databases may have different data types for certain fields. For example, a high-precision decimal value in the source database may need to be rounded or truncated to fit into a lower-precision data type in the target database. This can lead to data loss or distortion.
(D) Data Truncation: If the target database has stricter constraints on data length or size, data may need to be truncated or truncated, potentially leading to data loss or corruption.
(E) Downtime Constraints: In many cases, there are strict limitations on the amount of downtime that can be tolerated. This can make it challenging to complete the migration within a limited timeframe.

To address the above and other challenges and to improve the efficiency, reliability, and resilience of data migration, a more robust and flexible approach is necessary.

These and other needs are addressed by the various embodiments and configurations of the present invention. The present invention can provide a number of advantages depending on the particular configuration. These and other advantages will be apparent from the disclosure of the invention(s) contained herein.

In some aspects, the techniques described herein relate to a method for managing database migration, including: comparing a first hash value of a root node of a first set of nodes forming a first Merkle tree, to a second hash value of a root node of a second set of nodes forming a second Merkle tree and each of the first set of nodes maps to a corresponding each of the second set of nodes; upon determining the first hash value and the second hash value are not equal, identifying a first leaf node of the first Merkle tree having a first hash different from a second hash of a second leaf node of the second Merkle tree corresponding to the first leaf node of the first Merkle tree, wherein the first hash is determined from hashing a number of source records and the second hash is determined from hashing a number of destination records; and replacing the number of destination records with the number of source records.

In some aspects, the techniques described herein relate to a method, wherein the first hash value and the second hash value are determined to be equal when the first hash value is non-identical to the second hash value and the number of source records are equivalent to the number of destination records.

In some aspects, the techniques described herein relate to a method, wherein the number of source records are equivalent to the number of destination records when the value of a first data element of a first source record of the number of source records differs from the value of a second data element of a first destination record and the value of the first data element is equivalent to the value of the second data element after converting the one of (a) the value of the first data element to a data type of the value of the second data element or (b) the value of the second data element to the data type of the value of the first data element.

In some aspects, the techniques described herein relate to a method, wherein the data type of the value of the first data element and the data type of the value of the second data element include different numerical precision.

In some aspects, the techniques described herein relate to a method, wherein the data type of the value of the first data element and the data type of the value of the second data element include different formats.

In some aspects, the techniques described herein relate to a method, wherein identifying the first leaf node of the first Merkle tree having a first hash different from a second hash of the corresponding second leaf node of the second Merkle tree, includes: traversing the first Merkle tree and the second Merkle tree including comparing a hash value of a first sub-node of the first Merkle tree to a hash value of a second sub-node of the second Merkle tree; and upon determining the hash value of the first sub-node does not equal the hash value of the second sub-node, traversing the first Merkle tree and the second Merkle tree including setting a child node of the first sub-node as the first sub-node and setting a corresponding child node of the second sub-node as the second sub-node.

In some aspects, the techniques described herein relate to a method, further including, upon determining the hash value of the first sub-node equals the hash value of the second sub-node, excluding the first sub-node and all child nodes thereof and the second sub-node and all child nodes thereof, from the traversal.

In some aspects, the techniques described herein relate to a method, wherein: the first leaf node is a leaf node of a set of leaf nodes of the first Merkle tree; and the first hash is a hash value of a set of first hash values for corresponding members of the set of leaf nodes of the first Merkle tree.

In some aspects, the techniques described herein relate to a method, wherein: the second leaf node is a leaf node of a set of leaf nodes of the second Merkle tree; and the second hash is a hash value of a set of second hash values for corresponding members of the set of leaf nodes of the second Merkle tree.

In some aspects, the techniques described herein relate to a system for managing database migration, including: a source data storage including a number of source records; a destination data storage including a number of destination records; and a processor including a non-transitory memory having instructions therein to cause the processor to perform: comparing a first hash value of a root node of a first set of nodes forming a first Merkle tree, to a second hash value of a root node of a second set of nodes forming a second Merkle tree and each of the first set of nodes maps to a corresponding each of the second set of nodes; upon determining the first hash value and the second hash value are not equal, identifying a first leaf node of the first Merkle tree having a first hash different from a second hash of a second leaf node of the second Merkle tree corresponding to the first leaf node of the first Merkle tree, wherein the first hash is determined from hashing the number of source records and the second hash is determined from hashing the number of destination records; and replacing the number of destination records with the number of source records.

In some aspects, the techniques described herein relate to a system, wherein the first hash value and the second hash value are determined to be equal when the first hash value is non-identical to the second hash value and the number of source records are equivalent to the number of destination records.

In some aspects, the techniques described herein relate to a system, wherein the number of source records are equivalent to the number of destination records when the value of a first data element of a first source record of the number of source records differs from the value of a second data element of a first destination record and the value of the first data element is equivalent to the value of the second data element after converting the one of (a) the value of the first data element to a data type of the value of the second data element or (b) the value of the second data element to the data type of the value of the first data element.

In some aspects, the techniques described herein relate to a system, wherein the data type of the value of the first data element and the data type of the value of the second data element include different numerical precision.

In some aspects, the techniques described herein relate to a system, wherein the data type of the value of the first data element and the data type of the value of the second data element include different formats.

In some aspects, the techniques described herein relate to a system, wherein the instructions to cause the processor to identify the first leaf node of the first Merkle tree having a first hash different from a second hash of a corresponding second leaf node of the second Merkle tree, include instructions to cause the processor to: traverse the first Merkle tree and the second Merkle tree including comparing a hash value of a first sub-node of the first Merkle tree to a hash value of a second sub-node of the second Merkle tree; and upon determining the hash value of the first sub-node does not equal the hash value of the second sub-node, travers the first Merkle tree and the second Merkle tree including setting a child node of the first sub-node as the first sub-node and setting a corresponding child node of the second sub-node as the second sub-node.

In some aspects, the techniques described herein relate to a system, further including instructions to cause the processor to, upon determining the hash value of the first sub-node equals the hash value of the second sub-node, exclude the first sub-node and all child nodes thereof and the second sub-node and all child nodes thereof, from the traversal.

In some aspects, the techniques described herein relate to a non-transitory computer readable medium including instructions that, when read by a machine, cause the machine to perform: comparing a first hash value of a root node of a first set of nodes forming a first Merkle tree, to a second hash value of a root node of a second set of nodes forming a second Merkle tree and each of the first set of nodes maps to a corresponding each of the second set of nodes; upon determining the first hash value and the second hash value are not equal, identifying a first leaf node of the first Merkle tree having a first hash different from a second hash of a corresponding second leaf node of the second Merkle tree, wherein the first hash is determined from hashing a number of source records and the second hash is determined from hashing a number of destination records; and replacing the number of destination records with the number of source records.

In some aspects, the techniques described herein relate to a non-transitory computer readable medium, wherein the first hash value and the second hash value are determined to be equal when the first hash value is non-identical to the second hash value and the number of source records are equivalent to the number of destination records.

In some aspects, the techniques described herein relate to a non-transitory computer readable medium, wherein the number of source records are equivalent to the number of destination records when the value of a first data element of a first source record of the number of source records differs from the value of a second data element of a first destination record and the value of the first data element is equivalent to the value of the second data element after converting the one of (a) the value of the first data element to a data type of the value of the second data element or (b) the value of the second data element to the data type of the value of the first data element.

In some aspects, the techniques described herein relate to a non-transitory computer readable medium, wherein the data type of the value of the first data element and the data type of the value of the second data element include different numerical precision.

A system on a chip (SoC) including any one or more of the above aspects or aspects of the embodiments described herein.

One or more means for performing any one or more of the above or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above aspects or aspects of the embodiments described herein, wherein the data storage comprises a non-transitory storage device, which may further comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a system in accordance with embodiments of the present disclosure;

FIG. 2 depicts a Merkle tree in accordance with embodiments of the present disclosure;

FIG. 3 depicts a Merkle tree comparison in accordance with embodiments of the present disclosure;

FIG. 4 depicts a resolution process in accordance with embodiments of the present disclosure. ; and

FIG. 5 depicts a device in a system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with the like reference number. When such a reference is made in the singular form, but without identification of the sub-reference identifier, it is a reference to one of the like numbered elements, but without limitation as to the particular one of the elements being referenced. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

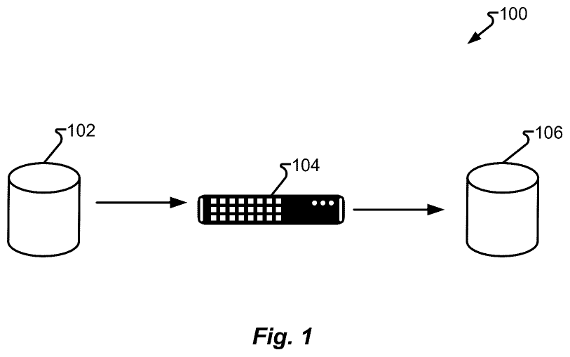

FIG. 1 illustrates system 100 in accordance with embodiments of the present disclosure. In one embodiment, data (e.g., tables, rows, databases, portions thereof, etc.) are migrated from source database 102 and written to destination database 106. Server 104 reads data from source database 102 and writes the data to destination database 106. Server 104 may validate the data, such as by Merkle trees of hash records from the source and from the destination to ensure the destination data is accurate (the source data in source database 102 may be considered authoritative in case of any discrepancy). If necessary, server 104 reconciles any differences therebetween.

In another embodiment, server 104 may convert data in source database 102 into a common or neutral format (e.g., ASCII, UTF-16, etc.) prior to migration. The hash version is then obtained from the common or neutral format. The migration may utilize the common or neutral format into destination database 106 or convert the data into a specific format. A hash of the common or neutral format from the destination data base 106, or a hashing of the data wrote to destination database 106 and converted to the common or neutral format, may then be compared to the hash of the common or neural format records from source database 102.

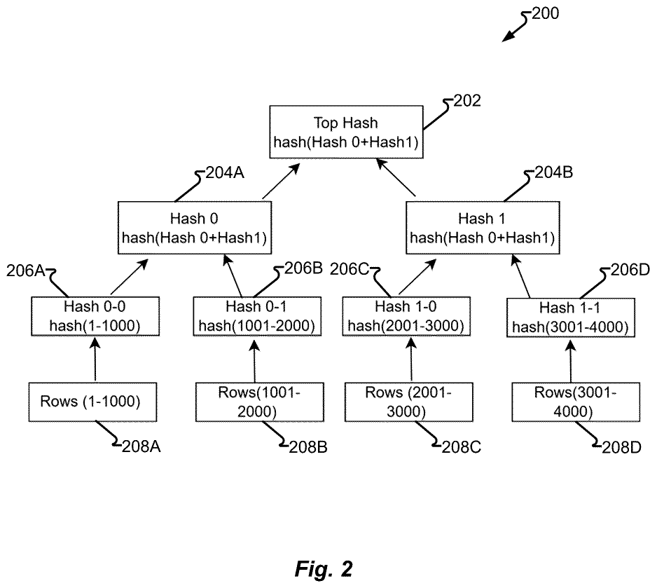

FIG. 2 illustrates Merkle tree 200 in accordance with embodiments of the present disclosure. Merkle trees are known data structures wherein the root node contains the hash value that is itself a hash of the hash value from a number, generally two, of sub-nodes. This pattern propagates down to the leaf nodes, the leaf nodes having a hash value determined from a data source. In certain embodiments herein, the leaf node hash values are determined from a number of database rows. The number of leaf nodes may be determined by a previously determined algorithm, such that the leaf nodes are not too fine or too coarse. For example, database rows 208A-208D each contain 1,000 rows. As used herein, the leaf nodes maintain a hash value from a plurality of rows, but no single leaf node maintains a hash value of all rows.

Merkle tree 200 illustrates one embodiment, wherein a database (not shown) comprises a number of rows 208A-208D, and the value of the rows are hashed to leaf nodes 206A-206D that correspond to rows 208A-208D. The hash value of the leaf nodes 206A-206D are then hashed to sub-nodes 204A-204B. The hash value of sub-nodes 204A-204B are then hashed to root node 202.

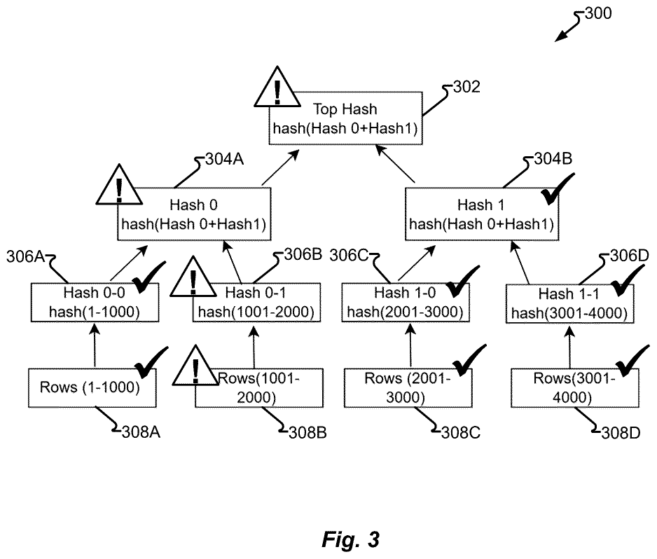

FIG. 3 illustrates a Merkle tree comparison in accordance with embodiments of the present disclosure. In one embodiment, Merkle tree 200 (see FIG. 2) comprises hash values from rows of a first database and Merkle tree 300 comprises hash values from a second database. In a further embodiment, the first database is a source database (e.g., source database 102) and the second database is the result of migrating the first database to become the second database (e.g., destination database 106). In another embodiment, Merkle tree 300 may be a copy (e.g., a duplicate, backup, etc.) of Merkle tree 200.

In another embodiment, Merkle tree 300 utilizes the same parsing paradigm as Merkle tree 200, such that each node of Merkle tree 200 has a corresponding node in Merkle tree 300. Rows 308A-308D are rows of the second database. Leaf nodes 306A-306D comprise hash values of the corresponding rows 308A-308D. The hash value of leaf nodes 306A-306D are then hashed to become hash values of sub-node 304A-304B. The hash value of sub-nodes 304A-304B are then hashed to determine the hash value of root node 302.

If the hash value of root node 202 and the hash value of root node 302 are the same, then the values of all the rows (e.g., rows 308A-308D) have been accurately migrated and no further processing is required. However, if the hash value of root node 202 and the hash value of root node 302 differs, then at least one block of rows (e.g., one or more of rows 308A-308D) differs from the corresponding at least one block of source rows (e.g., the corresponding one or more of rows 208A-208D).

Merkle tree 200 and Merkle tree 300 are traversed to compare the hash values therein to each other. In one embodiment, root node 302 of Merkle tree 300 have a different hash value than the root node 202 of Merkle tree 200 (illustrated by an exclamation mark in a triangle). The nodes of Merkle tree 200 and the corresponding nodes of Merkle tree 300 are traversed, such as the hash value of sub-node 304A of Merkle tree 300 being different than the hash value of sub-node 204A of Merkle tree 200. The hash value of sub-node 304B of Merkle tree 300 is the same as the hash value of sub-node 204B of Merkle tree 200 (illustrated by a checkmark). As a result, Merkle tree 200 and Merkle tree 300 are further traversed, starting with the next sub-nodes of sub-node 204A and sub-node 304A (having dissimilar hash values). Merkle tree 200 and Merkle tree 300 are not traversed any further with respect to sub-nodes of sub-node 204B and sub-node 304B (having the same hash values). There may be multiple layers of sub-nodes depending on the particular topology of Merkle tree 200 and Merkle tree 300.

Merkle tree 200 and Merkle tree 300 are further traversed (less any excluded nodes, e.g., sub-node 204B and sub-node 304B and their sub-nodes and leaf nodes). The hash value of leaf node 306A is compared to the hash value of leaf node 306A and, being the same, then excludes the rows' hash to form the respective hash values (e.g., rows 208A and rows 308A). The hash value of leaf node 206B is compared to the hash value of leaf node 306B and is found to be different. Accordingly, rows 308B are found to differ from rows 208B. Generally, and in one embodiment, the source (e.g., rows 208A-208D of the first database) are considered the authority and any differences are a discrepancy of the destination (e.g., rows 308A-308D of the second database). No other leaf nodes (e.g., leaf nodes 206C-206D and leaf nodes 306C-306D) need to be considered due to parent nodes having the same hash value (e.g., the hash value of sub-node 204B is the same as the hash value of sub-node 304B).

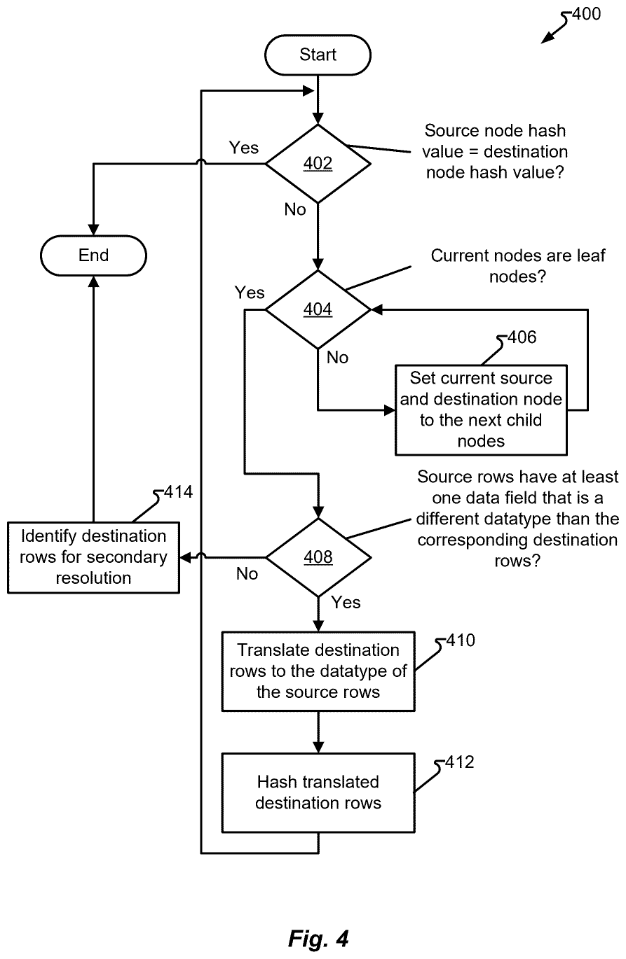

In the embodiment illustrated, rows 2001-3000 have a discrepancy. The discrepancy may be the value of a single field of a single row, one field of multiple rows, multiple fields of a single row, or multiple fields of multiple rows. The second (destination) database is then resolved (see FIG. 4).

FIG. 4 illustrates resolution process 400 in accordance with embodiments of the present disclosure. In one embodiment, test 402 compares the hash value of a source node to a corresponding hash value of a destination node (e.g., root node 202 to root node 302, sub-node 204A to sub-node 304A, etc.). If test 402 determines the hash values are the same, such as the hash values are the same for root node 202 and root node 302, then process 400 may end. If test 402 determines the hash values are the same for a sub-node (e.g., sub-node 204A and sub-node 304A have the same hash values), then process 400 may end and restart with a different pair of nodes (e.g., sub-node 204B and sub-node 304B). If all nodes at a level (root, all first-level sub-nodes, etc.), have been evaluated, then test 402, upon determining the last pair of nodes at the level are the same, may end process 400.

If test 402 determines the values are not the same, processing continues to test 404 to determine if the current nodes (e.g., the current source node and/or the corresponding destination node) are leaf nodes (e.g., one of leaf nodes 206A-206D and/or leaf nodes 306A-306D).

Then, if test 404 is determined in the negative, processing continues to step 406 to set the current nodes being processed to child nodes thereof. It should be appreciated that other tree traversals paradigms may be utilized in addition to, or as an alternative to, the traversal methodology illustrated herein without departing from the scope of the embodiments.

If or when test 404 determines the current nodes are leaf nodes, test 408 determines if there is a difference in the datatypes between the record blocks. For example at least one field has of a record stores a date as a string, in record 1999 of one of rows 208B, and the corresponding at least one field has a date as an integer value for record 1999 the corresponding one of rows 308B). If test 408 is determined in the affirmative, processing continues to step 410, which translates all or a portion of the destination rows. For example, the portion of a record having the at least one data field that is of a different datatype than the corresponding field of the at least one data field of the source row. In response, causing the same data value in the destination row to have the same datatype of the source row. Step 412 then hashes the destination row now translated to the same datatype of the source row. Processing continues back to step 402 to determine if the hash value of the source node is equal to the hash value of the translated destination node. If true, process 400 may end or restart with another node. If false, processing continues to test 404, and optionally step 406, and test 408. If test 408 is determined in the negative, then the value of a row differs in a way other than in the datatype (e.g., a true different value is present). Accordingly, step 414 may then execute secondary resolutions. Secondary resolutions may comprise one or more of manual resolution, remigrating the affected destination rows with the corresponding source rows, and/or another resolution.

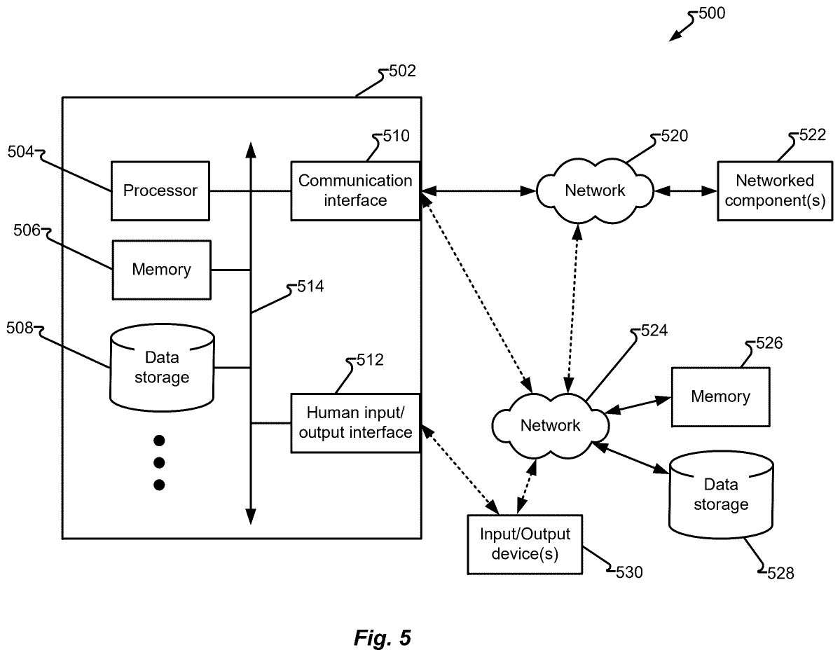

FIG. 5 depicts device 502 in system 500 in accordance with embodiments of the present disclosure. In one embodiment, server 104 may be embodied, in whole or in part, as device 502 comprising various components and connections to other components and/or systems. The components are variously embodied and may comprise processor 504. The term “processor,” as used herein, refers exclusively to electronic hardware components comprising electrical circuitry with connections (e.g., pin-outs) to convey encoded electrical signals to and from the electrical circuitry. Processor 504 may comprise programmable logic functionality, such as determined, at least in part, from accessing machine-readable instructions maintained in a non-transitory data storage, which may be embodied as circuitry, on-chip read-only memory, computer memory 506, data storage 508, etc., that cause the processor 504 to perform the steps of the instructions. Processor 504 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 514, executes instructions, and outputs data, again such as via bus 514. In other embodiments, processor 504 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 504 is a non-transitory computing device (e.g., electronic machine comprising circuitry and connections to communicate with other components and devices). Processor 504 may operate a virtual processor, such as to process machine instructions not native to the processor (e.g., translate the VAX operating system and VAX machine instruction code set into Intel® 9xx chipset code to enable VAX-specific applications to execute on a virtual VAX processor). However, as those of ordinary skill understand, such virtual processors are applications executed by hardware, more specifically, the underlying electrical circuitry and other hardware of the processor (e.g., processor 504). Processor 504 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

First database (e.g., source database 102) and/or second database (e.g., destination database 106) may be embodied to comprise data storage 508 and/or 528. In addition to the components of processor 504, device 502 may utilize computer memory 506 and/or data storage 508 for the storage of accessible data, such as instructions, values, etc. Communication interface 510 facilitates communication with components, such as processor 504 via bus 514 with components not accessible via bus 514 and may be embodied as a network interface (e.g., ethernet card, wireless networking components, USB port, etc.). Communication interface 510 may be embodied as a network port, card, cable, or other configured hardware device. Additionally or alternatively, human input/output interface 512 connects to one or more interface components to receive and/or present information (e.g., instructions, data, values, etc.) to and/or from a human and/or electronic device. Examples of input/output devices 530 that may be connected to input/output interface include, but are not limited to, keyboard, mouse, trackball, printers, displays, sensor, switch, relay, speaker, microphone, still and/or video camera, etc. In another embodiment, communication interface 510 may comprise, or be comprised by, human input/output interface 512. Communication interface 510 may be configured to communicate directly with a networked component or configured to utilize one or more networks, such as network 520 and/or network 524.

Network 520 may be a wired network (e.g., Ethernet), wireless (e.g., WiFi, Bluetooth, cellular, etc.) network, or combination thereof and enable device 502 to communicate with networked component(s) 522. In other embodiments, network 520 may be embodied, in whole or in part, as a telephony network (e.g., public switched telephone network (PSTN), private branch exchange (PBX), cellular telephony network, etc.).

Additionally or alternatively, one or more other networks may be utilized. For example, network 524 may represent a second network, which may facilitate communication with components utilized by device 502. For example, network 524 may be an internal network to a business entity or other organization, whereby components are trusted (or at least more so) than networked components 522, which may be connected to network 520 comprising a public network (e.g., Internet) that may not be as trusted.

Components attached to network 524 may include computer memory 526, data storage 528, input/output device(s) 530, and/or other components that may be accessible to processor 504. For example, computer memory 526 and/or data storage 528 may supplement or supplant computer memory 506 and/or data storage 508 entirely or for a particular task or purpose. As another example, computer memory 526 and/or data storage 528 may be an external data repository (e.g., server farm, array, “cloud,” etc.) and enable device 502, and/or other devices, to access data thereon. Similarly, input/output device(s) 530 may be accessed by processor 504 via human input/output interface 512 and/or via communication interface 510 either directly, via network 524, via network 520 alone (not shown), or via networks 524 and 520. Each of computer memory 506, data storage 508, computer memory 526, data storage 528 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 530 may be a router, a switch, a port, or other communication component such that a particular output of processor 504 enables (or disables) input/output device 530, which may be associated with network 520 and/or network 524, to allow (or disallow) communications between two or more nodes on network 520 and/or network 524. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components by, in one or more embodiments, voltages in memory circuits, configuration of switching circuits, and/or by selective use of particular logic gate circuits. Additionally or alternatively, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessors may be integrated into a single processing appliance (e.g., computer, server, blade, etc.) or located entirely, or in part, in a discrete component and connected via a communications link (e.g., bus, network, backplane, etc. or a plurality thereof).

Examples of general-purpose microprocessors may comprise a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMS, EPROMS, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, a first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® 15-4670K and i7-4770K 22 nm Haswell, Intel® Core® i5-3570K 22nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A method for managing database migration, comprising:
comparing a first hash value of a root node of a first set of nodes forming a first Merkle tree, to a second hash value of a root node of a second set of nodes forming a second Merkle tree,
wherein each node of the first set of nodes maps to a corresponding node of the second set of nodes;
upon determining that the first hash value and the second hash value are not equal, identifying a first leaf node of the first Merkle tree having a first hash different from a second hash of a second leaf node of the second Merkle tree corresponding to the first leaf node of the first Merkle tree,
wherein the first hash is determined from hashing a number of source records and the second hash is determined from hashing a number of destination records; and
replacing the number of destination records with the number of source records.

2. The method of claim 1, wherein the first hash value and the second hash value are determined to be equal when the first hash value is non-identical to the second hash value and the number of source records are equivalent to the number of destination records.

3. The method of claim 2, wherein the number of source records are equivalent to the number of destination records when a value of a first data element of a first source record of the number of source records differs from a value of a second data element of a first destination record and the value of the first data element is equivalent to the value of the second data element after converting one of (a) the value of the first data element to a data type of the value of the second data element or (b) the value of the second data element to the data type of the value of the first data element.

4. The method of claim 3, wherein the data type of the value of the first data element and the data type of the value of the second data element comprise different numerical precisions.

5. The method of claim 3, wherein the data type of the value of the first data element and the data type of the value of the second data element comprise different formats.

6. The method of claim 1, wherein identifying the first leaf node of the first Merkle tree having a first hash different from a second hash of the corresponding second leaf node of the second Merkle tree, comprises:
traversing the first Merkle tree and the second Merkle tree comprising comparing a hash value of a first sub-node of the first Merkle tree to a hash value of a second sub-node of the second Merkle tree; and
upon determining the hash value of the first sub-node does not equal the hash value of the second sub-node, traversing the first Merkle tree and the second Merkle tree comprising setting a child node of the first sub-node as the first sub-node and setting a corresponding child node of the second sub-node as the second sub-node.

7. The method of claim 6, further comprising, upon determining the hash value of the first sub-node equals the hash value of the second sub-node, excluding the first sub-node and all child nodes thereof and the second sub-node and all child nodes thereof, from the traversal.

8. The method of claim 1, wherein:
the first leaf node is a leaf node of a set of leaf nodes of the first Merkle tree; and
the first hash is a hash value of a set of first hash values for corresponding members of the set of leaf nodes of the first Merkle tree.

9. The method of claim 1, wherein:
the second leaf node is a leaf node of a set of leaf nodes of the second Merkle tree; and
the second hash is a hash value of a set of second hash values for corresponding members of the set of leaf nodes of the second Merkle tree.

10. A system for managing database migration, comprising:
a source data storage comprising a number of source records;
a destination data storage comprising a number of destination records; and
a processor comprising a non-transitory memory having instructions therein to cause the processor to perform:
comparing a first hash value of a root node of a first set of nodes forming a first Merkle tree, to a second hash value of a root node of a second set of nodes forming a second Merkle tree,
wherein each node of the first set of nodes maps to a corresponding node of the second set of nodes;
upon determining that the first hash value and the second hash value are not equal, identifying a first leaf node of the first Merkle tree having a first hash different from a second hash of a second leaf node of the second Merkle tree corresponding to the first leaf node of the first Merkle tree,
wherein the first hash is determined from hashing the number of source records and the second hash is determined from hashing the number of destination records; and
replacing the number of destination records with the number of source records.

11. The system of claim 10, wherein the first hash value and the second hash value are determined to be equal when the first hash value is non-identical to the second hash value and the number of source records are equivalent to the number of destination records.

12. The system of claim 11, wherein the number of source records are equivalent to the number of destination records when a value of a first data element of a first source record of the number of source records differs from a value of a second data element of a first destination record and the value of the first data element is equivalent to the value of the second data element after converting one of (a) the value of the first data element to a data type of the value of the second data element or (b) the value of the second data element to the data type of the value of the first data element.

13. The system of claim 12, wherein the data type of the value of the first data element and the data type of the value of the second data element comprise different numerical precisions.

14. The system of claim 12, wherein the data type of the value of the first data element and the data type of the value of the second data element comprise different formats.

15. The system of claim 10, wherein the instructions to cause the processor to identify the first leaf node of the first Merkle tree having a first hash different from a second hash of a corresponding second leaf node of the second Merkle tree, comprise instructions to cause the processor to:
traverse the first Merkle tree and the second Merkle tree comprising comparing a hash value of a first sub-node of the first Merkle tree to a hash value of a second sub-node of the second Merkle tree; and
upon determining the hash value of the first sub-node does not equal the hash value of the second sub-node, travers the first Merkle tree and the second Merkle tree comprising setting a child node of the first sub-node as the first sub-node and setting a corresponding child node of the second sub-node as the second sub-node.

16. The system of claim 15, further comprising instructions to cause the processor to, upon determining the hash value of the first sub-node equals the hash value of the second sub-node, exclude the first sub-node and all child nodes thereof and the second sub-node and all child nodes thereof, from the traversal.

17. A non-transitory computer readable medium comprising instructions that, when read by a machine, cause the machine to perform:
comparing a first hash value of a root node of a first set of nodes forming a first Merkle tree, to a second hash value of a root node of a second set of nodes forming a second Merkle tree,
wherein each node of the first set of nodes maps to a corresponding node of the second set of nodes;
upon determining that the first hash value and the second hash value are not equal, identifying a first leaf node of the first Merkle tree having a first hash different from a second hash of a corresponding second leaf node of the second Merkle tree,
wherein the first hash is determined from hashing a number of source records and the second hash is determined from hashing a number of destination records; and
replacing the number of destination records with the number of source records.

18. The non-transitory computer readable medium of claim 17, wherein the first hash value and the second hash value are determined to be equal when the first hash value is non-identical to the second hash value and the number of source records are equivalent to the number of destination records.

19. The non-transitory computer readable medium of claim 17, wherein the number of source records are equivalent to the number of destination records when a value of a first data element of a first source record of the number of source records differs from a value of a second data element of a first destination record and the value of the first data element is equivalent to the value of the second data element after converting one of (a) the value of the first data element to a data type of the value of the second data element or (b) the value of the second data element to the data type of the value of the first data element.

20. The non-transitory computer readable medium of claim 19, wherein:
comparing the first hash value of the root node of the first set of nodes forming the first Merkle tree, to the second hash value of the root node of the second set of nodes forming the second Merkle tree,
wherein each node of the first set of nodes maps to the corresponding node of the second set of nodes, comprises: (i) converting the first has value of the root node to a neutral format; and (ii) converting the second hash value of the root node of the second set of nodes to the neutral format; and
comparing the first hash value of the root node, in the neural format, of the first set of nodes forming the first Merkle tree, to the second hash value of the root node, in the neural format, of the second set of nodes forming the second Merkle tree.
